(19) United States
(12) Patent Application Publication
(10) Pub. No.: US 2015/0226972 A1
(43) Pub. Date: Aug. 13, 2015

(54) BACKLIGHT MODULE AND DOUBLE VISION DISPLAY DEVICE

(71) Applicant: BOE Technology Group Co., Ltd., Beijing (CN)

(72) Inventor: Shang Wang, Beijing (CN)

(21) Appl. No.: 14/314,612

(22) Filed: Jun. 25, 2014

(30) Foreign Application Priority Data
Feb. 7, 2014 (CN) 201410045257.9

(51) Int. Cl. G02B 27/12; F21V 8/00

(52) U.S. Cl. CPC G02B 27/126; G02B 6/0033

(57) ABSTRACT

An aspect of the present invention provides a backlight module for a double vision display device. The backlight module includes a light splitting prism film, which is provided with a plurality of first prisms. The plurality of first prisms are positioned side by side on a light incident surface of the light splitting prism film and extend along a first direction. Another aspect of the present invention provides a double vision display device comprising the above mentioned backlight module. The backlight module comprises a light splitting prism film, which is provided with a plurality of first prisms. The plurality of first prisms are positioned side by side on a light incident surface of the light splitting prism film and extend along a first direction. The double vision display device may be used in an onboard double vision display device, or a double vision display device of a computer or a mobile phone and the like.

### CROSS-REFERENCE TO RELATED APPLICATION

This application claims the benefit of Chinese Patent Application No. 201410045257.9 filed on Feb. 7, 2014 in the State Intellectual Property Office of China, the whole disclosure of which is incorporated herein by reference.

### BACKGROUND OF THE INVENTION

1. Field of the Invention

The present invention relates to a display device, and particularly, to a backlight module and a double vision display device including the same.

2. Description of the Related Art

Recently, with wider use of liquid crystal display products, technology relating to liquid crystal display has been increasingly developed. TFT-LCD (Thin Film Transistor-Liquid Crystal Display) is widely used in display devices for high quality image displaying, low power consuming and environment friendly.

A double vision display device allows providing different images for users at different orientations via one single display screen. For example, when used in a car, a double vision display device may display a navigation image for the driver while providing entertainment video for passengers, thereby achieving cost and space saving. Herewith, a double vision display device has its wide market in, for example, airport, subway station, arena, and the like.

However, in current double vision display device, a prism film (or BEF, Brightness Enhancement Film) is typically used as a light splitter to achieve the effect of light splitting. This type of prism film has a planar side face used as a light incident face and a light exit face provided with a plurality of prisms. The plurality of prisms have apexes that are not configured at 90 degree. It is to be noted that, when the prism film of this type is used in a double vision display device, it has disadvantages in light intensity attenuation in the crosstalk region between the two viewing angles, which will adversely affect the viewing-angle splitting performance of the double vision display. Thus, the resulting separated video displaying by this double vision display device is disadvantageously affected.

### SUMMARY OF THE INVENTION

The present invention has been made to overcome or alleviate at least one aspect of the above mentioned disadvantages.

According to an aspect of the present invention, a backlight module for a double vision display device is provided. The backlight module includes a light splitting prism film provided with a plurality of first prisms. The plurality of first prisms are positioned side by side on a light incident surface of the light splitting prism film and extend along a first direction.

According to another aspect of the present invention, a double vision display device is provided to comprise the above mentioned backlight module. The backlight module comprises a light splitting prism film provided with a plurality of first prisms. The plurality of first prisms are positioned side by side on a light incident surface of the light splitting prism film and extend along a first direction. The double vision display device may include an onboard double vision display device, or a double vision display device of a computer or a mobile phone and the like.

With the use of the above backlight module in a double vision display device, double vision display at two different displaying angles is obtained while light emission is constrained in the crosstalk region located between the two displaying angles during the double vision display mode.

### BRIEF DESCRIPTION OF THE DRAWINGS

The above and other features of the present invention will become more apparent by describing in detail exemplary embodiments thereof with reference to the accompanying drawings, in which:

FIG. 1 is a schematic perspective view of a backlight module according to an embodiment of the present invention;

FIG. 2 is a schematic light splitting principle diagram of a light splitting prism film of the backlight module according to the first embodiment of the present invention;

FIG. 3 is a schematic diagram of intensity distribution of light after being split by the light splitting prism film;

FIG. 4 is a schematic light splitting principle diagram of a light splitting prism film of the backlight module according to the second embodiment of the present invention;

FIG. 5 is a schematic light splitting principle diagram of a light splitting prism film of the backlight module according to the third embodiment of the present invention;

FIG. 6 is a schematic light splitting principle diagram of a light splitting prism film of the backlight module according to the fourth embodiment of the present invention;

FIG. 7 is a schematic light splitting principle diagram of a light splitting prism film of the backlight module according to the fifth embodiment of the present invention.

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art. Detailed description for well-known device, circuitry and method is omitted to simplify and clarify the description of the present invention.

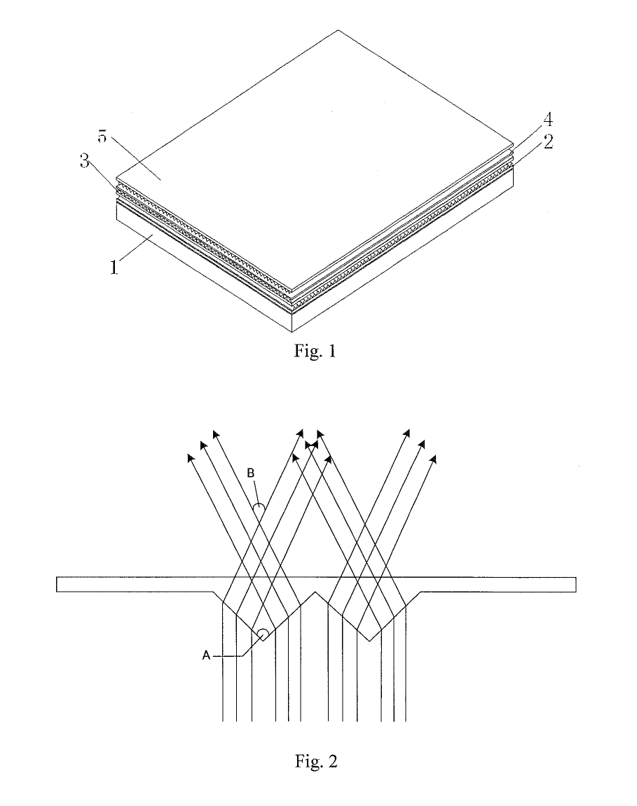

FIG. 1 is a schematic perspective view of a backlight module according to an exemplary embodiment of the present invention. As shown in FIG. 1, the backlight module may include a light guiding plate 1, a first concentrating prism film 2, a second concentrating prism film 3, a scattering film 4, and a light splitting prism film 5, arranged in this order from light incident side to light exit side (i.e. from bottom to top in FIG. 1). It is noted that the light guiding plate 1, the first concentrating prism film 2, the second concentrating prism film 3, and the scattering film 4 shown in FIG. 1 are optional components in the embodiment, which are not necessary for carrying out the present invention.

Further, as illustrated in FIG. 1, the first concentrating prism film 2 and the second concentrating prism film 3 are disposed at light incident side of the light splitting prism film 5, wherein the prisms in the second concentrating prism film 3 extend in a first direction while the prisms in the first concentrating prism film 2 extend in a second direction that is perpendicular to the first direction, thereby restricting exit angle of light, such that exiting light is concentrated within range of front view to improve brightness of light therein. Further, the backlight module further includes a scattering film 4, which is disposed between the second concentrating prism film 3 and the light splitting prism film 5, for enhancing distribution uniformity of the exiting light from the backlight module.

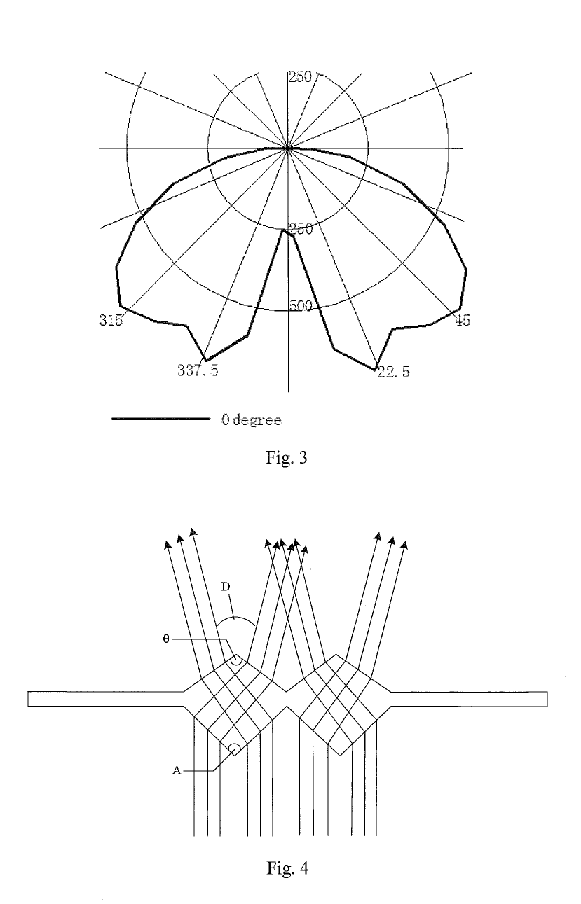

FIG. 2 is a schematic light splitting principle diagram of the light splitting prism film 5 of the backlight module according to the first embodiment of the present invention, showing the cross section of the light splitting prism film. As shown in FIG. 2, light beams (as shown by the arrowed line in the FIG. 2) incident to the lower surface (light incident surface) of the light splitting prism film 5 on the light incident side from below and exit from the upper surface (light exit surface) thereof on the light exit side. At light incident side of the light splitting prism film 5, a plurality of first prisms are disposed side by side, in which each of the first prisms extends in the first direction. It is noted that the plurality of first prisms may extend in an arbitrary direction in practice, as described below, although they are illustrated in the first embodiment to be extending in the first direction. At this point, as a light beam incidents into the light splitting prism film 5 from the light incident side, according to refraction law, it is refracted by a first prism(s) disposed on the light incident surface of the light splitting prism film 5. The light beam is split into two sub-beams, with one sub-beam being refracted to the right at the left side surface of the first prism, and the other one being refracted to the left at the right side surface of the first prism, as shown in FIG. 2. The two light sub-beams are directed towards two different directions as required for double vision displaying.

In addition, the backlight module further includes a light source (not shown). The light guiding plate comprises a first side surface facing the light splitting prism film, a second side surface opposite to the first side surface, and at least one peripheral surface extends between the first side surface and the second side surface. The light source is disposed on a side of the second side surface or the at least one peripheral surface. The light source is configured to provide light beam output for the backlight module. It is noted that, according to the lighting characteristic of the light source, the light source may include a Cold Cathode Fluorescent Lamp (CCFL), or a light emitting diode (LED) and the like. The light guiding plate 1 is configured to introduce and diffuse the light emitted by the light source.

As shown in FIG. 2, assume that light beams emitted by the light source (not shown) form a plurality of parallel light beams via other components of the backlight module (not shown), then the plurality of parallel light beams incident to the light splitting prism film, and particularly, enter the light incident side of the light splitting prism film along a direction that is perpendicular to the plane of the light splitting prism film. According to refraction law, the light beams that incident on the left side surfaces of the first prisms will be refracted to the right, and the light beams that incident on the right side surfaces of the first prisms will be refracted to the left, as shown in FIG. 2. So that the plurality of parallel light beams are divided into two groups of light -beams that are directed towards two different directions as required for double vision displaying.

As shown in FIG. 2, assumed that the apex angle of the first prism is A, the included angle between the two groups of exit light beams is B, the refractivity of the light splitting prism film is n1, and the refractivity of air external to the light splitting prism film is 1. Herein, the relationship between A and B satisfies the following formula:

$$B = 2 arc sin \{ n 1 \times sin [ \frac{1}{n 1} \times sin ( {90}^{°} - \frac{A}{2} ) ] - \frac{A}{2} \} .$$

As the light beams are refracted towards two different directions by the left and the right side surfaces of the first light splitting prism, light transmission in the direction between the two exiting directions is effectively restrained.

As further shown in FIG. 3, an intensity distribution of light after being split by the light splitting prism film in FIG. 2 is plotted. It can be seen that there are two regions having relatively high intensity of light, which correspond to the exiting directions of the light beams after being split by the light splitting prism film, and one region having relatively low intensity of light located between the above two regions. This proves that the light emission between the two exiting directions is effectively restrained by the light splitting prism film. Therefore, the backlight module according to the embodiment of the present invention further improves display performance of a double vision display device.

As an alternative of the first embodiment of the present invention, the light splitting prism film may be additionally provided with a plurality of protruded portions or recessed portions on light exit surface thereof Particularly, each of protruded portions or recessed portions is disposed oppositely to respective one of the first prisms and extends in a direction parallel to that of the first prism, so as to further control the light-splitting effect of the light splitting prism film.

FIG. 4 is a schematic cross section view of a light splitting prism film of a backlight module according to the second embodiment of the present invention. In this embodiment, the plurality of protruded portions provided on the light exit surface of the light splitting prism film are in the form of a plurality of second prisms. Each of the second prisms has an apex angle of θ that is larger than the apex angle (A) of the first prism and is arranged oppositely to a respective first prism. Therefore, the exiting light beams from each first prisms incident to a respective second prism and the second prisms further refract the light beams, so as to further control the included angle between the two groups of exiting light.

In addition to the assumes with respect to FIG. 2, if the included angle D between the two groups of light beams after being refracted by the second light splitting prisms, then the following formula is satisfied:

$$D = {180}^{°} - θ + 2 n 1 \times sin \{ {90}^{°} - \frac{θ}{2} - arc sin [ \frac{1}{n 1} \times sin ( {90}^{°} - \frac{A}{2} ) ] + \frac{A}{2} \} .$$

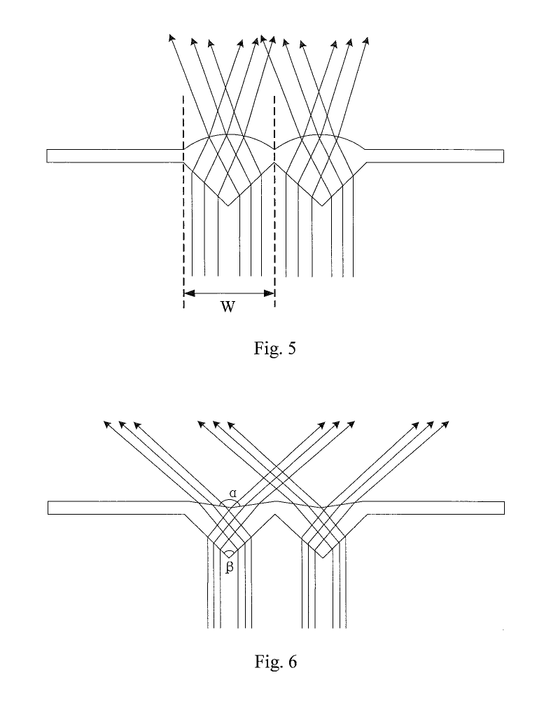

FIG. 5 illustrates a schematic cross section view of a light splitting prism film of a backlight module according to the third embodiment of the present invention. The light splitting prism film in this embodiment is provided with a plurality of protruding portions on its light exiting surface, which, particularly, are circular arc shaped protrusions. Each of the plurality of circular arc shaped protrusions is disposed opposite to a respective first prism and each arcuate protrusion has a radius of curvature of R₁, and

$${R}_{1} \geq \frac{1}{2} W ,$$

where W is width of the first prism and the arcuate protrusion. The above configuration of the arcuate protrusions may achieve a convergence effect to scattered light beams.

In addition, the light splitting prism film may be also provided with recessed portions on its light exiting surface, so as to further control the light splitting effect of the light splitting prism film

For example, FIG. 6 illustrates a schematic cross section view of a light splitting prism film in a backlight module according to the fourth embodiment of the present invention. In this embodiment, the light splitting prism film is provided with a plurality of recessed portions on its light exiting surface, which, particularly, are V-shaped grooves (i.e., a recessed prism). Each V-shaped groove has an apex angle of a that is larger than that of the first prism β. Here, the light beams, after being refracted by the first prism incident to the V-shape grooves, which further refract the light beams, thereby further controlling light splitting action. It can be seen that, comparing with the situation that only the first prisms are provided, light separating angle would be enlarged if the apex angles α of the V-shaped grooves are set to be larger than that of the first prism β.

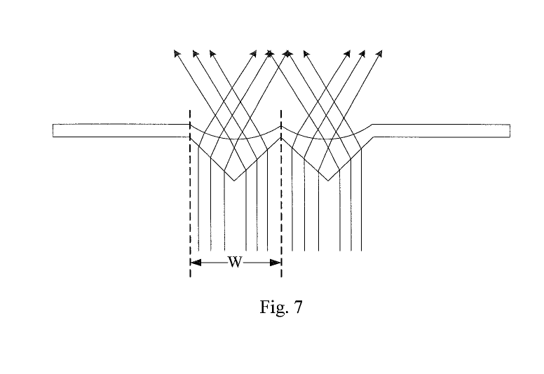

FIG. 7 is a schematic cross section view of a light splitting prism film in a backlight module according to the fifth embodiment of the present invention. In this embodiment, the light splitting prism film is provided with a plurality of recessed portions on its light exiting side. As shown in FIG. 7, the plurality of recessed portions are a plurality of arcuate grooves. Each of the arcuate grooves is disposed opposite to one first prism and has a radius of curvature of R₂, and

$${R}_{2} \geq \frac{1}{2} W ,$$

where W is width of the first prism and the arcuate groove. The configuration of the circular arc shaped grooves will further scatter the light beams.

Those skilled in the art may adjust associated parameters of the light splitting prism film, such as, apex angle A of the first prism, apex angle θ of the second prism, radius of curvature of the circular arc shaped protrusion or groove, etc., to achieve desired light splitting action. In addition, although the first prism and/or the second prism disclosed in the embodiment are in the shape of triangle, the prism may be of different shapes that are common in this field to achieve different light splitting effects. When a material with different refractivity is used to form the light splitting prism film, the light splitting effect can be changed.

Various display modes may be obtained by disposing the prisms in different orientations on the light splitting prism film. For example, when the prisms extend in a vertical direction, two different images of the double vision angle display device can be seen by users in a left region and a right region in front of the display device respectively. When the prisms extend in a horizontal direction, the two different images can be seen by users in an upper region and a lower region in front of the display device, respectively. And when the prisms extend in an inclined orientation, the two different images can be seen by users for example in an upper right region and a lower left region in front of the display device respectively.

The material of the light splitting prism film may include transparent resin or transparent optical glass, and particularly, a resin material or optical glass material with high transmission. For example, the material of the light splitting prism film may include a high-transmission polymeric organic resin with a refractivity of 1.59. The use of a high-transmission resin or optical glass may reduce optical power loss during light splitting.

It is also noted that, the backlight module as shown in FIG. 1 is only an exemplary embodiment. It is obvious for those skilled in the art to modify the structure of the backlight module based on the above disclosure.

For example, another embodiment of the present invention provides a backlight module comprising a light guiding plate and a light splitting prism film disposed at a light exit side of the light guiding plate. The light splitting prism film is provided with a plurality of first prisms disposed side by side on its surface facing the light exit side of the light guiding plate. With this configuration, light emission between the two displaying angles is effectively restricted while ensuring sufficient light intensity in the direction of the two displaying angles.

In another aspect, an embodiment of the present invention provides a double vision display device comprising a backlight module. The backlight module includes a light guiding plate and a light splitting prism film disposed at a light exit side of the light guiding plate. The light splitting prism film is provided with a plurality of first prisms disposed side by side on its surface facing the light exit side of the light guiding plate. The double vision display device may further include other components that are known in the art and the description thereof is omitted herein. In particular, the double vision display device according to the present invention may be used for an inboard double vision display device, computer or mobile phone and the like.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is,:

1. A backlight module for a double vision display device, comprising:
a light splitting prism film provided with a plurality of first prisms, wherein the plurality of first prisms are positioned side by side on a light incident surface of the light splitting prism film and extend along a first direction.

2. The backlight module according to claim 1, wherein
the light splitting prism film is provided with a plurality of protruding portions or recessed portions on a light exiting surface thereof, each of the protruding portions or the recessed portions is disposed opposite to a corresponding one of the plurality of first prisms and extends along the first direction.

3. The backlight module according to claim 2, wherein
the protruding portion comprises a second prism or an arcuate protrusion;
the second prism has an apex angle that is larger than that of the first prism; and
the arcuate protrusion has a radius of curvature not less than a half of a width of the first prism on the light incident surface.

4. The backlight module according to claim 2, wherein
the recessed portion comprises a V-shaped groove or an arcuate groove;
the V-shape groove has an apex angle that is larger than that of the first prism; and
the arcuate groove has a radius of curvature not less than a half of a width of the first prism on the light incident surface.

5. The backlight module according to claim 1, wherein
the material of light splitting prism film comprises transparent resin or transparent optical glass.

6. The backlight module according to claim 1, wherein
the material of the light splitting prism film has a refractivity of 1.59.

7. The backlight module according to claim 1, wherein
the backlight module further comprises a light guiding plate disposed on the light incident side of the light splitting prism film.

8. The backlight module according to claim 7, wherein
the light guiding plate comprises a first side surface facing the light splitting prism film, a second side surface opposite to the first side surface, and at least one peripheral surface extends between the first side surface and the second side surface,
and wherein the backlight module further comprises a light source disposed on a side of the second side surface or the at least one peripheral surface.

9. The backlight module according to claim 1, wherein
the backlight module further comprises a first concentrating prism film and a second concentrating prism film, the second concentrating prism film being disposed on the light incident side of the light splitting prism film, the first concentrating prism film being disposed on a light incident side of the second concentrating prism film, and the prisms of the first concentrating prism film extending in a direction orthogonal to the direction along which the prisms of the second concentrating prism film extend.

10. The backlight module according to claim 9, wherein
the backlight module further comprises a scattering film disposed between the second concentrating prism film and the light splitting prism film.

11. A double vision display device comprising a backlight module, wherein
the backlight module comprises a light splitting prism film provided with a plurality of first prisms, wherein the plurality of first prisms are positioned side by side on a light incident surface of the light splitting prism film and extend along a first direction.

12. The double vision display device according to claim 11, wherein
the light splitting prism film is provided with a plurality of protruding portions or recessed portions on a light exiting surface thereof, each of the protruding portions or the recessed portions is disposed opposite to a corresponding one of the plurality of first prisms and extends along the first direction.

13. The double vision display device according to claim 12, wherein
the protruding portion comprises a second prism or an arcuate protrusion;
the second prism has an apex angle that is larger than that of the first prism; and
the arcuate protrusion has a radius of curvature not less than a half of a width of the first prism on the light incident surface.

14. The double vision display device according to claim 12, wherein
the recess portion comprises a V-shaped groove or an arcuate groove;
the V-shape groove has an apex angle that is larger than that of the first prism; and
the arcuate groove has a radius of curvature not less than a half of a width of the first prism on the light incident surface.

15. The double vision display device according to claim 11, wherein
the material of light splitting prism film comprises transparent resin or transparent optical glass.

16. The double vision display device according to claim 11, wherein
the material of the light splitting prism film has a refractivity of 1.59.

17. The double vision display device according to claim 11, wherein
the backlight module further comprises a light guiding plate disposed on the light incident side of the light splitting prism film.

18. The double vision display device according to claim 17, wherein
the light guiding plate comprises a first side surface facing the light splitting prism film, a second side surface opposite to the first side surface, and at least one peripheral surface extends between the first side surface and the second side surface,
and wherein the backlight module further comprises a light source disposed on a side of the second side surface or the at least one peripheral surface.

19. The double vision display device according to claim 11, wherein
the backlight module further comprises a first concentrating prism film and a second concentrating prism film, the second concentrating prism film being disposed on the light incident side of the light splitting prism film, the first concentrating prism film being disposed on a light incident side of the second concentrating prism film, and the prisms of the first concentrating prism film extending in a direction orthogonal to the direction along which the prisms of the second concentrating prism film extend.

20. The double vision display device according to claim 19, wherein
the backlight module further comprises a scattering film disposed between the second concentrating prism film and the light splitting prism film.
